(19) United States
(12) Patent Application Publication
(10) Pub. No.: US 2023/0277925 A1
(43) Pub. Date: Sep. 7, 2023

(54) ADJUSTABLE BALANCED CONTROLLER HANDLE

(71) Applicant: Meta Platforms Technologies, LLC, Menlo Park, CA (US)

(72) Inventor: James Stocker Webb, Seattle, WA (US)

(21) Appl. No.: 18/177,569

(22) Filed: Mar. 2, 2023

Related U.S. Application Data
(60) Provisional application No. 63/315,939, filed on Mar. 2, 2022.

(51) Int. Cl. A63F 13/24; A63F 13/57

(52) U.S. Cl. CPC A63F 13/24; A63F 13/57; A63F 2300/8082

(57) ABSTRACT

Adjustable balanced controller handles are disclosed as well as methods, systems, and storage media for simulating weight through a controller configured for interacting in a virtual environment. Exemplary implementations may: receive a selection of an implement in the virtual environment; and adjust a location of a mass within a hollow portion of a handle of the controller based on the selection. The mass may be movable within the hollow portion to simulate inertia of a virtual object.

### CROSS REFERENCE TO RELATED APPLICATIONS

This present application claims the benefit of priority under 35 U.S.C. § 119(e) to U.S. Provisional Application No. 63/315,939, filed Mar. 2, 2022, the disclosure of which is hereby incorporated by reference in its entirety for all purposes.

### TECHNICAL FIELD

The present disclosure generally relates to controllers for virtual environments, and more particularly to adjustable balanced controller handles.

### BRIEF SUMMARY

The subject disclosure provides for systems and methods for controllers for virtual environments. According to some aspects, a controller may be configured for interacting in a virtual environment. The controller may include a handle comprising a hollow portion within the handle. The controller may include a mass within the hollow portion of the handle. The mass may be movable within the hollow portion to simulate inertia of a virtual object. The handle may be tube-shaped. The hollow portion may be tube-shaped. The virtual object may include an implement. The implement may include one or more of a weapon, a tool, and/or other implements. The mass may include a weight.

One aspect of the present disclosure relates to a method for simulating weight through a controller configured for interacting in a virtual environment. The method may include receiving a selection of an implement in the virtual environment. The method may include adjusting a location of a mass within a hollow portion of a handle of the controller based on the selection.

Another aspect of the present disclosure relates to a system configured for simulating weight through a controller configured for interacting in a virtual environment. The system may include one or more hardware processors configured by machine-readable instructions. The processor(s) may be configured to receive a selection of an implement in the virtual environment. The processor(s) may be configured to adjust a location of a mass within a hollow portion of a handle of the controller based on the selection.

Yet another aspect of the present disclosure relates to a non-transient computer-readable storage medium having instructions embodied thereon, the instructions being executable by one or more processors to perform a method for simulating weight through a controller configured for interacting in a virtual environment. The method may include receiving a selection of an implement in the virtual environment. The method may include adjusting a location of a mass within a hollow portion of a handle of the controller based on the selection.

Still another aspect of the present disclosure relates to a system configured for simulating weight through a controller configured for interacting in a virtual environment. The system may include means for receiving a selection of an implement in the virtual environment. The system may include means for adjusting a location of a mass within a hollow portion of a handle of the controller based on the selection.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example adjustable balanced controller handle, in accordance with one or more implementations.

FIG. 2 illustrates a system configured for simulating weight through a controller configured for interacting in a virtual environment, in accordance with one or more implementations.

FIG. 3 illustrates a method for simulating weight through a controller configured for interacting in a virtual environment, in accordance with one or more implementations.

FIG. 4 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

When in VR, there are a variety of experiences where users may want to use different tools, weapons, or other implements in the virtual environment. It may be challenging for the user to feel that they have an implement that may be longer or shorter when using a single controller. As an example, using a dagger will feel very different than using a long sword.

Exemplary implementations may include a hollow tube that has a heavy mass in the tube. The mass can be moved from top to bottom to change the center of gravity/inertia. Thus the balance of a controller may be tuned to meet the right feel and optimize the play/performance. This can also be used to simulate a feeling of holding a heavy blade or shovel (e.g., if the weight is at the top).

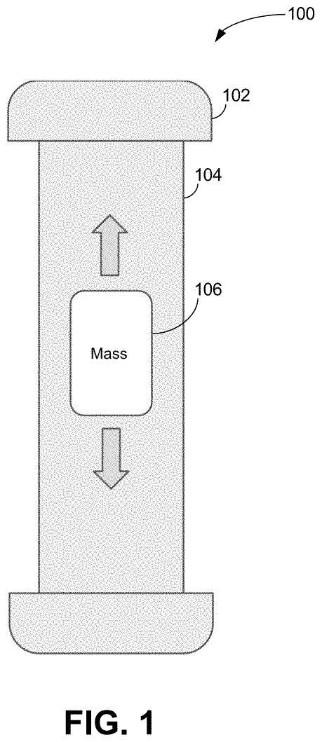

FIG. 1 illustrates an example adjustable balanced controller handle 100, in accordance with one or more implementations. The controller 100 may be configured for interacting in a virtual environment. The controller 100 may include a handle 102. The handle 102 may include a hollow portion 104 within the handle 102. The handle 102 may be tube-shaped. The hollow portion 104 may be tube-shaped. A mass 106 may be movable within the hollow portion 104 of the handle 102. The mass 106 may include a weight. The mass 106 may be movable within the hollow portion 104 to simulate inertia of a virtual object. The virtual object comprises an implement. By way of non-limiting example, the implement may include one or more of a weapon, a tool, and/or other implements.

The disclosed system(s) address a problem in traditional controllers for virtual environments techniques tied to computer technology, namely, the technical problem of providing tactile feedback to users of virtual environments that simulates real-world experiences. The disclosed system solves this technical problem by providing a solution also rooted in computer technology, namely, by providing for adjustable balanced controller handles. The disclosed subject technology further provides improvements to the functioning of the computer itself because it improves processing and efficiency in controllers for virtual environments.

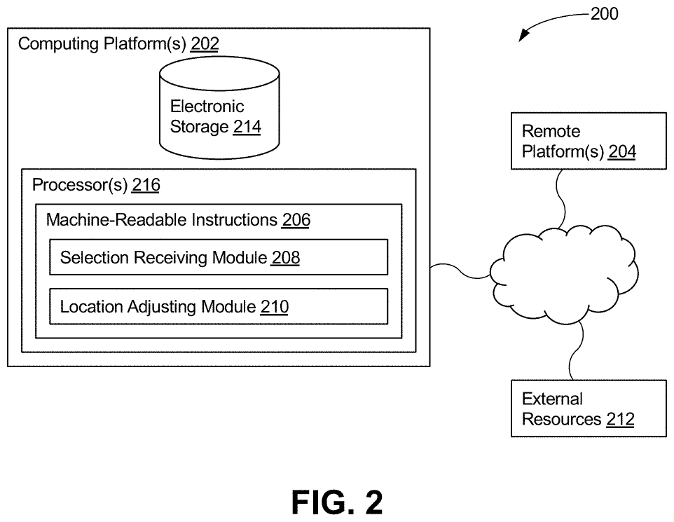

FIG. 2 illustrates a system 200 configured for simulating weight through a controller configured for interacting in a virtual environment, in accordance with one or more implementations. In some implementations, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of selection receiving module 208, location adjusting module 210, and/or other instruction modules.

Selection receiving module 208 may be configured to receive a selection of an implement in the virtual environment.

Location adjusting module 210 may be configured to adjust a location of a mass within a hollow portion of a handle of the controller based on the selection.

In some implementations, computing platform(s) 202, remote platform(s) 204, and/or external resources 212 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 212 may be operatively linked via some other communication media.

A given remote platform 204 may include one or more processors configured to execute computer program modules. The computer program modules may be configured to enable an expert or user associated with the given remote platform 204 to interface with system 200 and/or external resources 212, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, an augmented reality device, a virtual reality device, and/or other computing platforms.

External resources 212 may include sources of information outside of system 200, external entities participating with system 200, and/or other resources. In some implementations, some or all of the functionality attributed herein to external resources 212 may be provided by resources included in system 200.

Computing platform(s) 202 may include electronic storage 214, one or more processors 216, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 214 may comprise non-transitory storage media that electronically stores information. The electronic storage media of electronic storage 214 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 214 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 214 may include one or more virtual storage resources (e.g., cloud storage, a virtual private network, and/or other virtual storage resources). Electronic storage 214 may store software algorithms, information determined by processor(s) 216, information received from computing platform(s) 202, information received from remote platform(s) 204, and/or other information that enables computing platform(s) 202 to function as described herein.

Processor(s) 216 may be configured to provide information processing capabilities in computing platform(s) 202. As such, processor(s) 216 may include one or more of a digital processor, an analog processor, a digital circuit designed to process information, an analog circuit designed to process information, a state machine, and/or other mechanisms for electronically processing information. Although processor(s) 216 is shown in FIG. 2 as a single entity, this is for illustrative purposes only. In some implementations, processor(s) 216 may include a plurality of processing units. These processing units may be physically located within the same device, or processor(s) 216 may represent processing functionality of a plurality of devices operating in coordination. Processor(s) 216 may be configured to execute modules 208 and/or 210, and/or other modules. Processor(s) 216 may be configured to execute modules 208 and/or 210, and/or other modules by software; hardware; firmware; some combination of software, hardware, and/or firmware; and/or other mechanisms for configuring processing capabilities on processor(s) 216. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208 and/or 210 are illustrated in FIG. 2 as being implemented within a single processing unit, in implementations in which processor(s) 216 includes multiple processing units, one or more of modules 208 and/or 210 may be implemented remotely from the other modules. The description of the functionality provided by the different modules 208 and/or 210 described below is for illustrative purposes, and is not intended to be limiting, as any of modules 208 and/or 210 may provide more or less functionality than is described. For example, one or more of modules 208 and/or 210 may be eliminated, and some or all of its functionality may be provided by other ones of modules 208 and/or 210. As another example, processor(s) 216 may be configured to execute one or more additional modules that may perform some or all of the functionality attributed below to one of modules 208 and/or 210.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

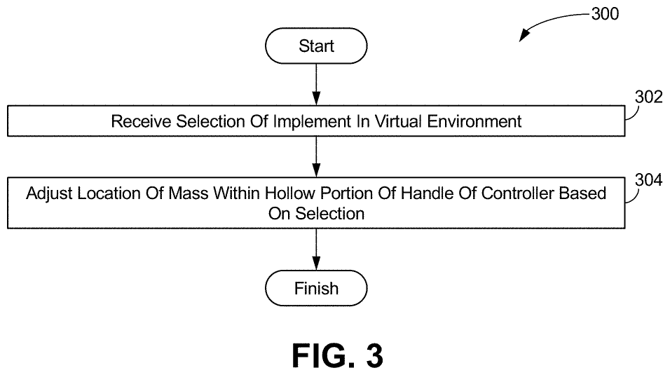

FIG. 3 an example flow diagram (e.g., process 300) for adjustable balanced controller handles, according to certain aspects of the disclosure. For explanatory purposes, the example process 300 is described herein with reference to FIG. 2. Further for explanatory purposes, the steps of the example process 300 are described herein as occurring in serial, or linearly. However, multiple instances of the example process 300 may occur in parallel. For purposes of explanation of the subject technology, the process 300 will be discussed in reference to FIG. 2.

At step 302, the process 300 may include receiving a selection of an implement in the virtual environment. At step 304, the process 300 may include adjusting a location of a mass within a hollow portion of a handle of the controller based on the selection.

For example, as described above in relation to FIG. 2, at step 302, the process 300 may include receiving a selection of an implement in the virtual environment, through selection receiving module 208. At step 304, the process 300 may include adjusting a location of a mass within a hollow portion of a handle of the controller based on the selection, through location adjusting module 210.

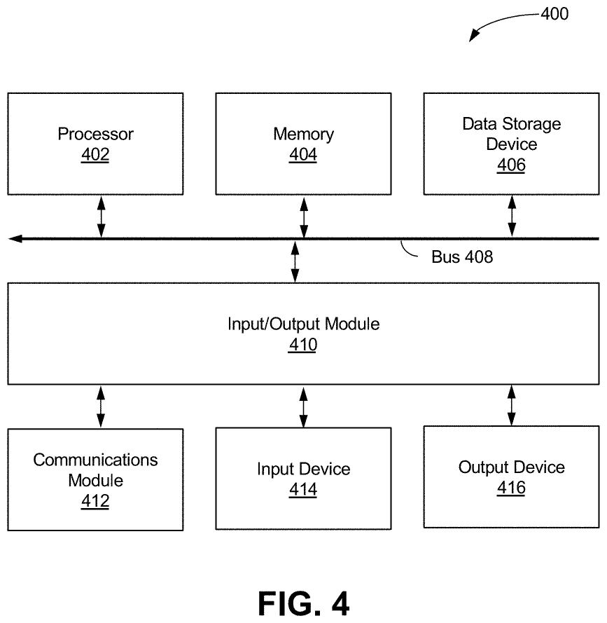

FIG. 4 is a block diagram illustrating an exemplary computer system 400 with which aspects of the subject technology can be implemented. In certain aspects, the computer system 400 may be implemented using hardware or a combination of software and hardware, either in a dedicated server, integrated into another entity, or distributed across multiple entities.

Computer system 400 (e.g., server and/or client) includes a bus 408 or other communication mechanism for communicating information, and a processor 402 coupled with bus 408 for processing information. By way of example, the computer system 400 may be implemented with one or more processors 402. Processor 402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 400 can include, in addition to hardware, code that creates an execution environment for the computer program in question, e.g., code that constitutes processor firmware, a protocol stack, a database management system, an operating system, or a combination of one or more of them stored in an included memory 404, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 408 for storing information and instructions to be executed by processor 402. The processor 402 and the memory 404 can be supplemented by, or incorporated in, special purpose logic circuitry.

The instructions may be stored in the memory 404 and implemented in one or more computer program products, i.e., one or more modules of computer program instructions encoded on a computer readable medium for execution by, or to control the operation of, the computer system 400, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 404 may also be used for storing temporary variable or other intermediate information during execution of instructions to be executed by processor 402.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 400 further includes a data storage device 406 such as a magnetic disk or optical disk, coupled to bus 408 for storing information and instructions. Computer system 400 may be coupled via input/output module 410 to various devices. The input/output module 410 can be any input/output module. Exemplary input/output modules 410 include data ports such as USB ports. The input/output module 410 is configured to connect to a communications module 412. Exemplary communications modules 412 include networking interface cards, such as Ethernet cards and modems. In certain aspects, the input/output module 410 is configured to connect to a plurality of devices, such as an input device 414 and/or an output device 416. Exemplary input devices 414 include a keyboard and a pointing device, e.g., a mouse or a trackball, by which a user can provide input to the computer system 400. Other kinds of input devices 414 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 416 include display devices such as an LCD (liquid crystal display) monitor, for displaying information to the user.

According to one aspect of the present disclosure, the above-described gaming systems can be implemented using a computer system 400 in response to processor 402 executing one or more sequences of one or more instructions contained in memory 404. Such instructions may be read into memory 404 from another machine-readable medium, such as data storage device 406. Execution of the sequences of instructions contained in the main memory 404 causes processor 402 to perform the process steps described herein. One or more processors in a multi-processing arrangement may also be employed to execute the sequences of instructions contained in memory 404. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 400 can include clients and servers. A client and server are generally remote from each other and typically interact through a communication network. The relationship of client and server arises by virtue of computer programs running on the respective computers and having a client-server relationship to each other. Computer system 400 can be, for example, and without limitation, a desktop computer, laptop computer, or tablet computer. Computer system 400 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to processor 402 for execution. Such a medium may take many forms, including, but not limited to, non-volatile media, volatile media, and transmission media. Non-volatile media include, for example, optical or magnetic disks, such as data storage device 406. Volatile media include dynamic memory, such as memory 404. Transmission media include coaxial cables, copper wire, and fiber optics, including the wires that comprise bus 408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 400 reads game data and provides a game, information may be read from the game data and stored in a memory device, such as the memory 404. Additionally, data from the memory 404 servers accessed via a network the bus 408, or the data storage 406 may be read and loaded into the memory 404. Although data is described as being found in the memory 404, it will be understood that data does not have to be stored in the memory 404 and may be stored in other memory accessible to the processor 402 or distributed among several media, such as the data storage 406.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include”, “have”, or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration”. Any embodiment described herein as “exemplary” is not necessarily to be construed as preferred or advantageous over other embodiments.

A reference to an element in the singular is not intended to mean “one and only one” unless specifically stated, but rather “one or more”. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A controller configured for interacting in a virtual environment, comprising:
a handle comprising a hollow portion within the handle; and
a mass within the hollow portion of the handle, the mass movable within the hollow portion to simulate inertia of a virtual object.

2. The controller of claim 1, wherein the handle is tube-shaped.

3. The controller of claim 1, wherein the hollow portion is tube-shaped.

4. The controller of claim 1, wherein the virtual object comprises an implement.

5. The controller of claim 4, wherein the implement comprises one or more of a weapon, a tool, and/or other implements.

6. A method for simulating weight through a controller configured for interacting in a virtual environment, comprising:
receiving a selection of an implement in the virtual environment; and
adjusting a location of a mass within a hollow portion of a handle of the controller based on the selection.

7. A system configured for simulating weight through a controller configured for interacting in a virtual environment, the system comprising:
one or more hardware processors configured by machine-readable instructions to:
receive a selection of an implement in the virtual environment; and
adjust a location of a mass within a hollow portion of a handle of the controller based on the selection.
